(19) United States
(12) Patent Application Publication
(10) Pub. No.: US 2017/0020336 A1
(43) Pub. Date: Jan. 26, 2017

(54) Removable Grill Drain Pan Liner

(71) Applicant: ColBar LLC, Louisville, CO (US)

(72) Inventors: Jeffrey A. Cole, Louisville, CO (US); David Barton, Bloomington, IL (US)

(21) Appl. No.: 15/202,823

(22) Filed: Jul. 6, 2016

Related U.S. Application Data
(60) Provisional application No. 62/189,007, filed on Jul. 6, 2015.

(51) Int. Cl. A47J 37/07

(52) U.S. Cl. CPC A47J 37/0786; A47J 37/0704

(57) ABSTRACT

A drain pan liner is provided for use in a drain pan of a grill having a grate, a drain pan, and a drain outlet for grease. The drain pan liner includes a rigid bottom and sides, and an end has an opening for flowing grease out of the grill. The liner is sized and shaped to fit into the drain pan. The drain pan liner is constructed and arranged such that it may be lifted out of the drain pan or inserted into the drain pan without requiring the grate or the drain pan to be removed from the grill, or the drain pan to be disarranged. The drain pan liner is sufficiently tough and rigid to resist tearing or collapsing.

### BACKGROUND OF THE INVENTION

U.S. Pat. App. No. 62/189,007, filed 6 Jul. 2015, is incorporated herein by reference.

### FIELD OF THE INVENTION

The present invention relates to grill drain pan liners. In particular, the present invention relates to pellet grill drain pan liners insertable and removable by a user without removing permanent parts of the grill.

### DISCUSSION OF RELATED ART

Most types of pellet grill cooking apparatus have been specially designed to cook with indirect heat. This is achieved in part through the use of a “drip” or “drain” pan which covers a fire pot and dispenses the heat indirectly throughout the cooking unit. This drain pan is designed to transfer grease by the use of gravity to a drain bucket attached outside of the unit. However, problems with this design occur as the pan retains residue grease and food particles and needs frequent cleaning. This cleaning requires the removal of permanent parts of the cooking unit, including the cooking grate and the drain pan itself—both large and heavy. Some manufacturers recommend removing these parts from the unit and covering the pan in aluminum foil between each cook. However, in addition to requiring the removal of permanent parts of the cooking unit to do this, aluminum foil regularly leaks, tears and leaves residue on the pan itself. Because of the time and effort to remove both the grate, which is necessary to access the drain pan, and remove and clean the drain pan, most users infrequently clean their drain pan. As a result, most pans are layered in grease which is both a fire hazard as well as impacting taste because of burned grease.

A need remains in the art for apparatus and methods for protecting drip or drain pans without requiring removal of permanent parts of the grill.

### SUMMARY OF THE INVENTION

It is an object of the present invention to provide apparatus and methods for protecting drip or drain pans without requiring removal of permanent parts of the grill

A drain pan liner is provided for use in a drain pan of a grill having a grate, a drain pan, and a drain hole for grease. The drain pan liner includes a bottom, sides, and an end formed of a rigid material and sized and shaped to fit into the drain pan, and a drain opening in the end sized and oriented to be adjacent to a drain pan drain in the end of the drain pan. The drain pan liner is constructed and arranged such that it may be lifted out of the drain pan or inserted into the drain pan without requiring the grate or the drain pan to be removed from the grill, or the drain pan to be disarranged.

The drain pan liner may include ridges formed along a bottom of the drain pan liner. It may also include structure for facilitating resizing of the drain pan, such as markings to indicate cut lines, and/or structure (such as perforations) to facilitate tearing.

A plurality of drain pan liners may be stacked for insertion into the drain pan such that a top drain pan liner may be lifted away without disarranging either the drain pan or the remaining drain pan liners in the stack.

In use, a user can easily clean grease and food particles from a grill having a grate and a drain pan by moving the grate out of the way, inserting a drain pan liner into the drain pan, replacing the grate and cooking with the grill. After cooking, the user again displaces the grate and removes the drain pan liner, taking any remaining grease and food particles with it.

Some grills allow the grate to be pivoted upward and out of the way. This allows a user to move the grate with one hand, remove an old drain pan liner with a second hand, and then insert a new drain pan liner with the second hand. Other grills have two or three piece grates which sit side by side. After sliding one grate on top of the other, the user can remove the old drain pan liner in same manner, sliding grates back to their original position when done. This can be done very quickly—easily in under a minute, and often in under 15 seconds.

The user may also use a stack of drain pan liners. The entire stack is inserted within the drain pan. After cooking, the user removes only the top drain pan liner and leaves the rest of the stack in place. This makes the process even quicker.

### BRIEF DESCRIPTION OF THE DRAWINGS

FIG. 1 (Prior Art) is an isometric view of a pellet grill with a conventional drain pan.

FIG. 2 (Prior Art) is an exploded view of the grill and drain pan of FIG. 1.

FIG. 3 is an isometric view of a pellet grill having a conventional drain pan, with a removable drain pan liner according to the present invention.

FIG. 4 is an isometric view of the grill, drain pan, and removable drain pan liner according to the present invention, illustrating the process of removing and replacing the drain pan liner.

FIG. 5 is an isometric view of the drain pan liner of FIGS. 3 and 4.

FIG. 6 is a detailed view of a portion of FIG. 3, showing the drain area in greater detail.

FIG. 7 is a side isometric view of the grill of FIGS. 1, 2, 3, 4, and 6 from the outside, including a drain bucket.

FIG. 8 is a cutaway isometric view of a second embodiment of a drain pan liner according to the present invention.

FIG. 9 is a top isometric view of the embodiment of FIG. 8 in use in a grill.

FIG. 10 is a flow diagram illustrating the use of a drain pan liner in accordance with the present invention.

FIG. 11 is a side cutaway view of a stack of drain pan liners in accordance with the present invention.

FIG. 12 is a top plan view of a drain pan liner including structure for resizing the drain pan liner according to the present invention.

### DETAILED DESCRIPTION OF THE INVENTION

Table 1 provides a list of reference numbers and associated elements used in this patent.

TABLE 1

| Reference | |
|---|---|
| number | Element |
| 100 | Drain pan liner |
| 102 | Drain pan liner length |
| 104 | Drain pan liner width |
| 108 | Drain pan liner edge |
| 110 | Drain pan liner aperture |
| 112 | Drain pan liner ridges |
| 114 | Drain pan liner bottom |
| 116 | Drain pan liner end |
| 150 | Grill |
| 152 | Grill grate |
| 154 | Grill lid |
| 156 | Aluminum foil |
| 160 | Grill drain opening |
| 200 | Drain pan liner second embodiment |
| 202 | Alternate drain pan length |
| 203 | Alternate drain pan length |
| 206 | Drain pan (conventional) |
| 208 | Second embodiment open end |
| 210 | Drain pan bottom |
| 212 | Drain pan edges |
| 214 | Second embodiment bottom |
| 216 | Drain pan end |
| 218 | Drain pan outlet channel |
| 220 | Bucket |
| 300 | Stack of drain pan liners |
| 312 | Resizable drain pan liner structure |
| 402-410 | Method steps |

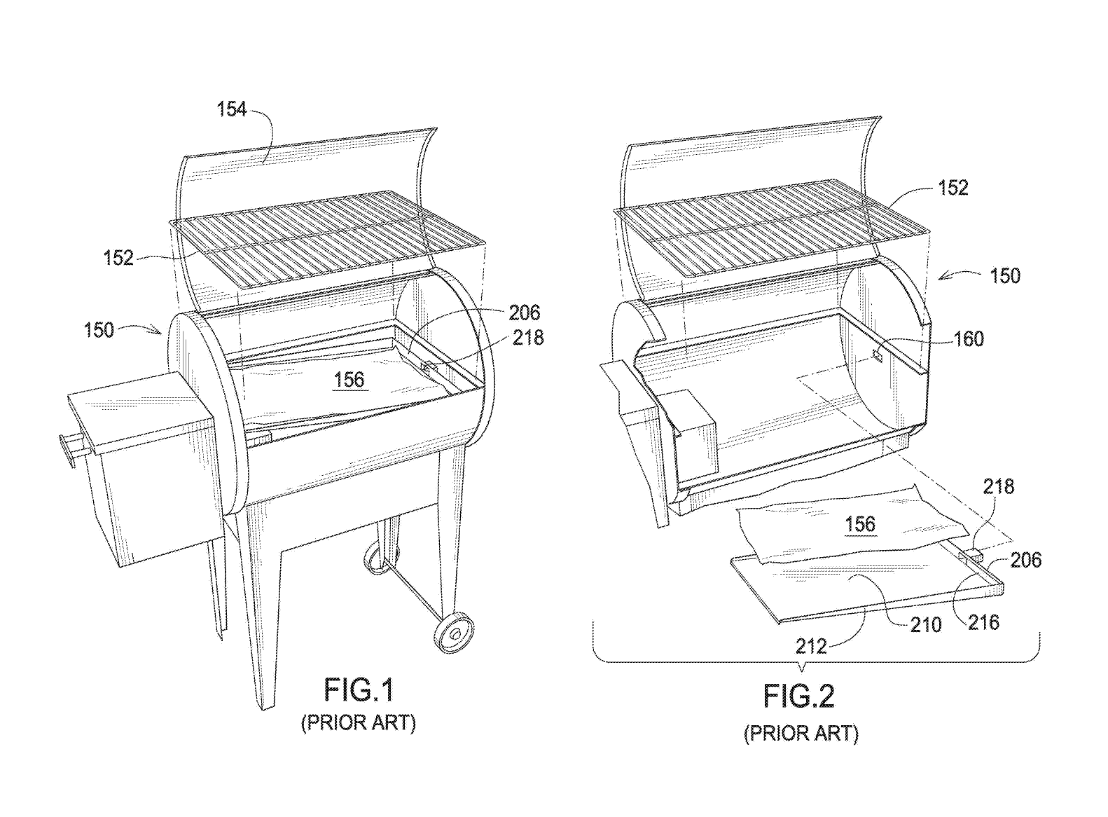

FIG. 1 (Prior Art) is an isometric view of a grill 150 with a conventional drain pan 206 for collecting run-off grease and fallen particles during the cooking process. Grate 152 has been lifted away for clarity. FIG. 2 (Prior Art) is an exploded view of grill 150 and drain pan 206 of FIG. 1. FIG. 2 also illustrates the process required to clean conventional drain pan 206, with or without inserted aluminum foil 156.

Grill or smoker 150 includes a lid 154 which generally swings open to allow access to grate 152. Food (not shown) is placed on grate 152 during the cooking process. Drain pan 206 is situated beneath grate 152 to collect grease and food particles that fall from grate 152. Drain pan 206 is slanted towards a lower end 216 which includes an outlet channel 218, allowing much of the grease to flow downward and through outlet channel 218 out of grill 150. A heating element (not shown), which may comprise charcoal or other fuel for burning, a firepot, or an electric heating element, provides heat under drain pan 206, which spreads the heat to evenly cook the food.

Grease and food particles remaining on drain pan 206 must be removed after cooking in order to prevent fires and burned grease and food particles flavoring the food. This cleaning process requires the removal of permanent parts of the grill 150, including cooking grate 152 and drain pan 206 itself—both large and heavy.

While some users leave drain pan 206 unlined, others cover it with aluminum foil 156 in order to keep drain pan 206 relatively clean. But aluminum foil 156 is fragile and tears easily allowing food and grease to leak onto drain pan 206.

Aluminum foil 156 may be placed only along the bottom 210 of drain pan 206 (as shown in FIGS. 1 and 2), which permits grease to flow under the edges of aluminum foil 156. This arrangement allows a user to remove foil 156 without removing drain pan 206 from grill 150. The user generally must remove grate 152 entirely from grill 150 and use both hands to remove foil 156. And drain pan 206 must still be removed entirely from grill 150 on a regular basis to clean residual grease and food particles from its surface.

Aluminum foil 156 may instead be wrapped around edges 212 of drain pan 206, which prevents grease from leaking under its edges. But this means that the user must remove drain pan 206 entirely from grill 150 to remove and replace foil 156. And since foil sticks to residual grease that “leaks” through and tears easily upon removal, drain pan 206 must still be cleaned fairly frequently. Thus, the user must still remove grate 152 and drain pan 206 on a regular basis, and clean drain pan 206.

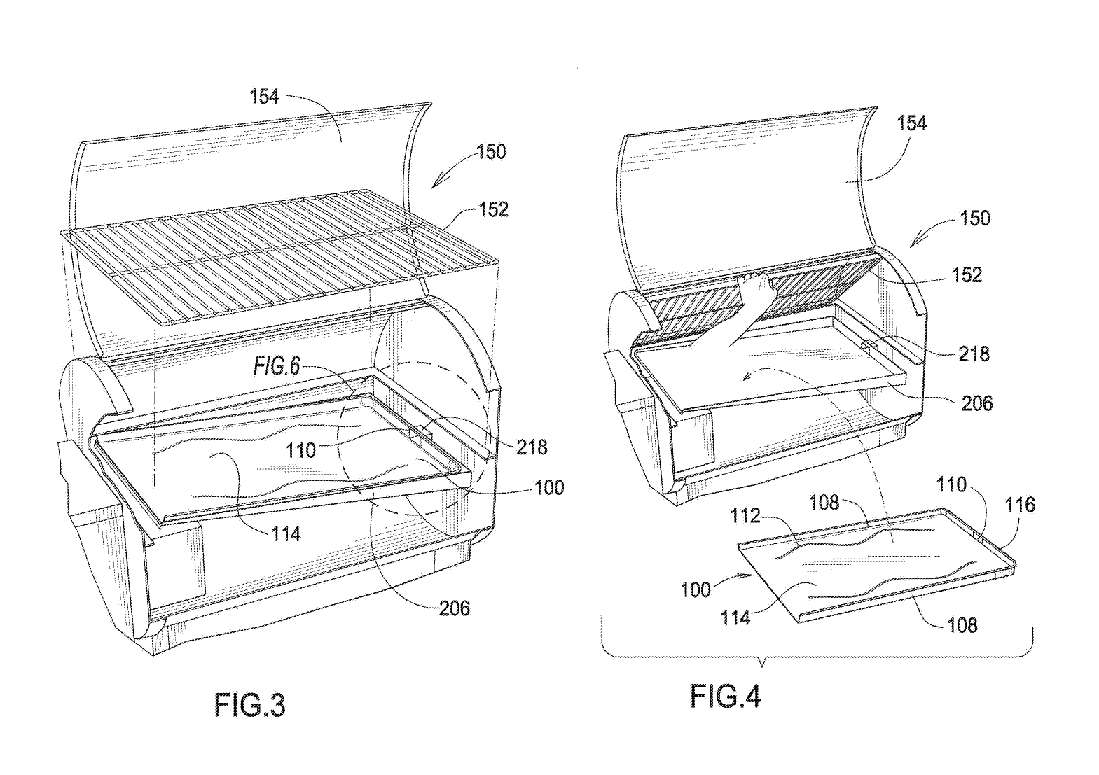

FIG. 3 is an isometric view of grill 150, with drain pan 206 and a removable drain pan liner 100 according to the present invention. While FIG. 3 shows grate 152 lifted away for clarity, FIG. 4 illustrates the process of removing drain pan liner 100. Drain pan liner 100 is shown in greater detail in FIG. 5.

Grill 150 includes the conventional elements shown in FIGS. 1 and 2: lid 154, grate 152, conventional drain pan 206, and drain hole 160. In addition, drain pan liner 100 according to the present invention is inserted into drain pan 206 in FIG. 3 and removed from drain pan 206 (and grill 150) in FIG. 4.

Drain pan liner 100 is shaped and sized for insertion into drain pan 206. It includes a drain opening 110 oriented adjacent to drain pan outlet channel 218, to allow grease to drain from grill 150. Drain pan liner 100 is formed of a tough, rigid material which will not sag or tear to allow grease or food to reach drain pan 206. It includes rigid sides 108 and end 116 so that grease does not flow under its edges and reach drain pan 206. It may include ridges 112 along its bottom 114 in order to aid the flow of grease.

In use, drain pan liner 100 is placed within drain pan 206. In some embodiments, drain pan liner 100 is sized to fit snugly within drain pan 206. Sides 108 may extend over edges 212 of drain pan 206 to essentially seal drain pan 206 from grease and food.

Removal of drain pan liner 100 is quick and easy. No permanent parts of grill 150 must be removed. Grate 152 is simply pivoted upward slightly and grill pan liner 100 is removed. This can be done in one step as a user pivot grate 152 with one hand and lifts out grill pan liner 100 with the other. A new drain pan liner 100 may be dropped in with the same hand that removed the old grill pan liner 100. The entire process generally takes under a minute.

Since grill pan liner 100 is rigid and tough, and has sides 108 and end 116, essentially no grease or food particles ever reach grill pan 206. Thus grill pan 206 essentially never needs cleaning, and doesn't need to be removed from grill 150. This also means grate 152 doesn't need to be entirely removed from grill 150—only pivoted upward slightly when grill pan liner 100 is replaced.

FIG. 5 shows one embodiment of a drain pan liner 100 according to the present invention. This drain pan liner 100 is rectangular, shaped to fit in a rectangular drain pan 206. Drain pan liner 100 is shown with a length 102 of, for example, 31½ inches, but the liners may have a length from about 15 inches to about 108 inches depending on the size of drain pan 206. Other lengths 202 and 203 are indicated. Further, drain pan liner 100 is shown with a width 104 of, for example, 15⅜ inches, but drain pan liner 100 may have a width from about 12 to about 40 inches, depending on the size of drain pan 206. Edges 108 are shown having a height of, for example, ¾ of an inch but may range in height from about ¼ of an inch to about 4 inches. Edges 108 may sit substantially against wall 210 of drain pan 206, to help to hold drain pan liner 100 in place and provide extra structural support.

Conventional drain pans 106 generally have outlet channel(s) 218 at one or both ends so that grease may flow out of the drain pan. Hence, drain pan liner 100 will preferably include drain opening(s) 110 sized and oriented to match up with outlet channel(s) 218. The embodiment of FIG. 5 includes one drain opening 110 constructed and arranged to be adjacent to outlet channel 218 (see FIG. 2) when drain pan liner 100 is placed within drain pan 206.

The embodiment of FIG. 5 includes a drain opening 110 which is, for example, 2 inches wide, but drain pan liners 100 may have drain openings 110 ranging from about ½ inch to about 3 inches, depending on the drain pan 106 outlet channel 218.

Drain pan liner 100 may also have grooves or ridges (e.g., ridges 112) to give drain pan liner 100 more rigidity and/or to direct grease flow. As shown, ridges 112 run generally parallel across the length of drain pan liner 100. Other implementations may include a variety of ridge configurations (i.e. ridges in a V shape that direct the flow of grease towards drain opening 110).

Drain pan liner 100 may be made of a heavy-duty industrial aluminum foil or sheeting having a thickness of about 0.0025 to about 0.004 inches or more, other metallic foils or sheeting, reinforced parchment paper, neoprene, or other materials. In some implementations, the drain pan liner 100 is a laminate of multiple layers of materials. The drain pan liner 100 material is preferably sturdy/thick enough to prevent tearing during placement, use, and removal. The material of drain pan liner 100 is preferably also rigid enough to avoid collapsing when inserted or removed, and is resistant to heat. Further, the drain pan liner 100 material may be recyclable.

Drain pan liner 100 may be sized to fit a number of different types of grills or smokers such as Traeger®, Yoder, Camp Chef®, Smoking Brothers®, Green Mountain®, Louisiana Grills, etc. Each drain pan liner 100 may be configured to fit a certain grill or smoker. For example, a drain pan liner may be configured to fit a smoker that is round.

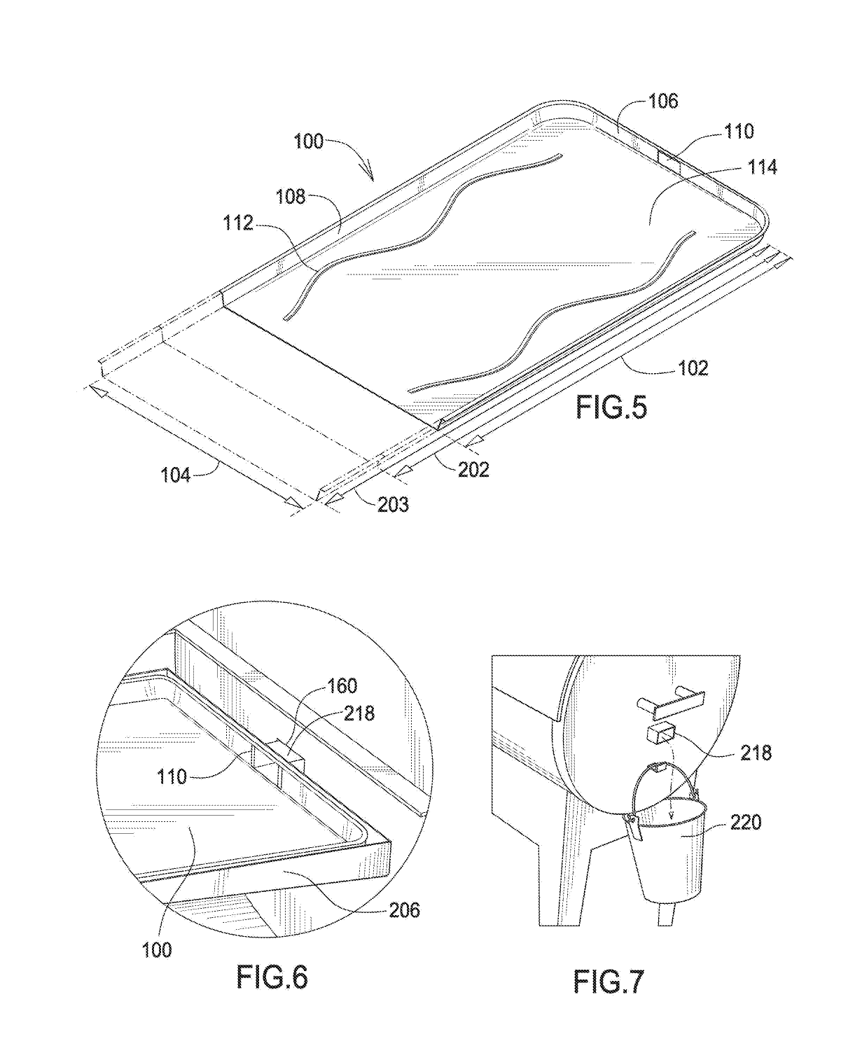

FIG. 6 is a detailed view of a portion of FIG. 3, showing the drain area in greater detail. FIG. 7 is a side isometric view of grill 150 from the outside, including a drain bucket 220.

Drain pan liner 100 drain opening 110 is sized and oriented to match up with drain pan 206 outlet channel 218. Outlet channel 218, in turn, is inserted into grill 150 drain opening 160. Thus grease flows along drain pan liner 100, and flows through drain opening 110, drain pan outlet channel 218, and grill drain opening 160 to flow into bucket 220.

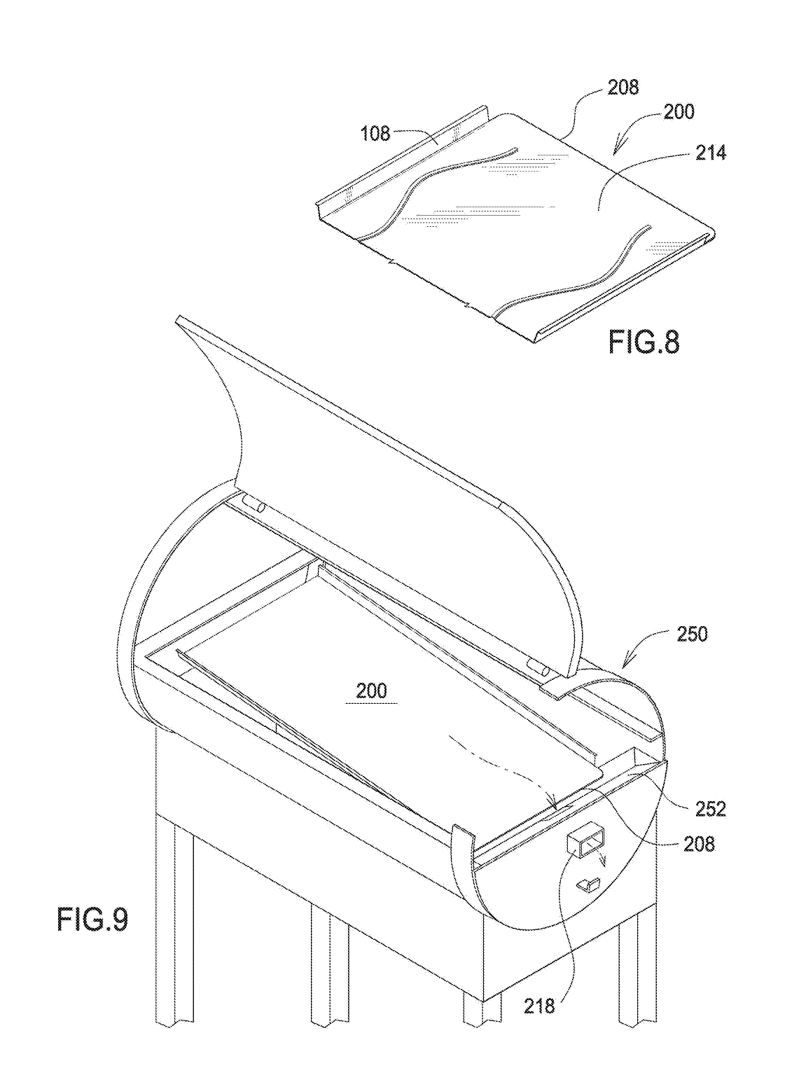

FIG. 8 is a cutaway isometric view of a second embodiment of a drain pan liner 200 according to the present invention. Bottom 214 of drain pan liner 200 includes an open end 208, rather than a closed end 116 with a drain opening 110 as in the first embodiment (see FIGS. 3-6). Drain pan liner 200 is structured for use in a second type of grill 250, shown in FIG. 9.

Grill 250 is similar to grill 150, except that the structure for draining grease from the grill is slightly different. Instead of a grill drain opening 160 through which a drain pan 206 outlet channel 218 is inserted, grill 250 has its own outlet channel 218 fed by a trough 252. Hence, a preferred embodiment of drain pan 250 is fitted with an open end 208 feeding into trough 252, for greater flow.

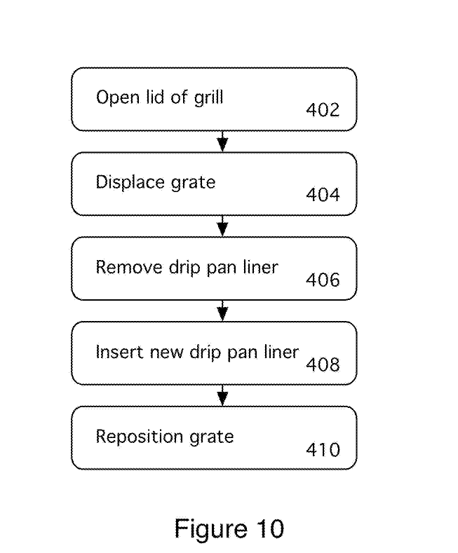

FIG. 10 is a flow diagram of a preferred embodiment of a method for removing and replacing drain pan liner 100. This method is useful with grills 150 wherein grate 156 can be pivoted upward to access drain pan 206. For other grills, the grate may need to be removed and set aside.

In step 402, a user opens lid 154 of grill 150, if it is closed. In step 404, the user pivots grate 152 slightly upward with one hand. In step 406, the user lifts drain pan liner 100 out of drain pan 206 and out of grill 150 with the other hand. In step 408, the user places a new drain pan liner within drain pan 106. In step 410, the user pivots grate 152 downward into its cooking position.

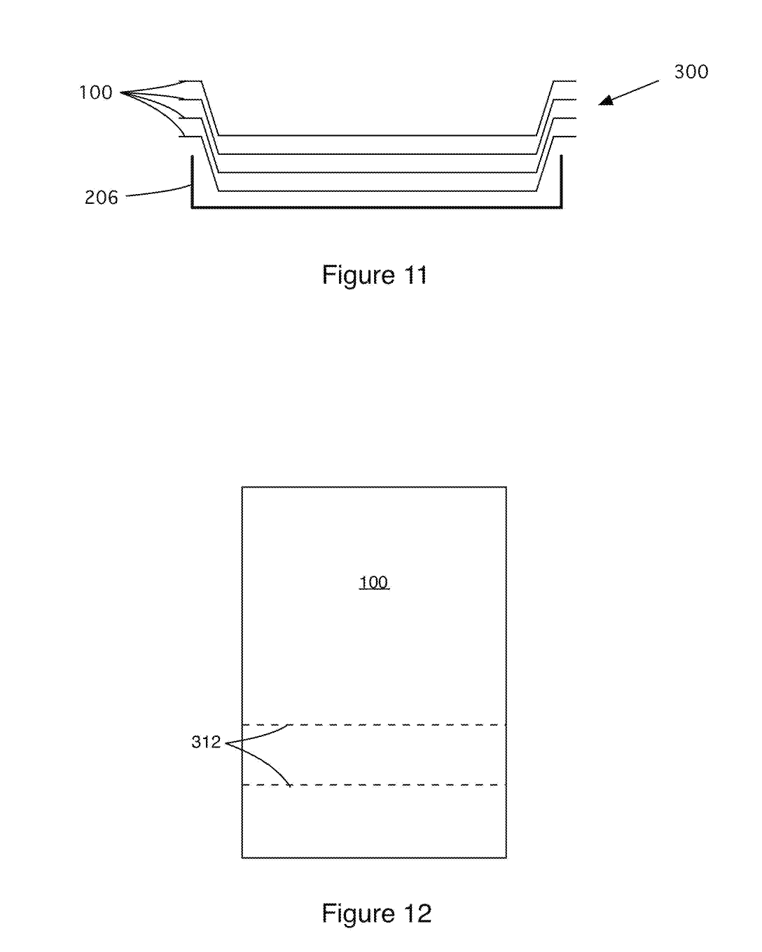

FIG. 11 is a side cutaway view of a stack 300 of drain pan liners 100 in accordance with the present invention. In a preferred embodiment, a stack 300 comprising multiple drain pan liners 100 are inserted into drain pan 206 together. After the grill or smoker is used, the top drain pan liner 100 is taken off the top of stack 300 and recycled or disposed of, leaving the rest of stack 300 in place. This leaves the topmost drain pan liner 100 substantially clean and ready for the next use of grill 150. In this implementation, this process may be repeated until the stack 300 of drain pan liners 150 has been used up. At this point, stack is 300 is replaced.

FIG. 12 is a top plan view of a drain pan liner 300 including structure 312 for resizing the drain pan liner according to the present invention. In this implementation, drain pan liner 100 is patterned and/or marked 312 in manner that allows it to be placed in a variety of different sized drain pans. In one embodiment, lines 312 in the drain pan liner are used as cut or folding points so that the liner will fit into different sized grills. Lines 312 or ridges may also be perforations that allow drain pan liner 100 to be easily torn along lines 312. For example, a user may be able to fold up, or cut or tear away a section of a side of a drain pan liner so that it may fit into a narrower drain pan.

Note that the term “grill” herein includes smokers and grills

While the exemplary preferred embodiments of the present invention are described herein with particularity, those skilled in the art will appreciate various changes, additions, and applications other than those specifically mentioned, which are within the spirit of this invention. For example, drain pan liner 100 could include ridges or grooves configured to allow drain pan liner 100 to be folded either before or after use. The drain pan liner may also have “tabs” that fold over sides of drain pan to help secure in place.

Further, drain pan liner 100 may have handles (not shown) that may allow for easier removal of the drain pan liner 100 after use. The handles may be placed in a manner such that they are not near any grease collection spots, thus providing a clean area to grab and lift the drain pan liner 100 out of a drain pan. The drain pan liner 100 may also have handles placed in a manner such that when grabbed and lifted up, the liner may fold along a ridge (e.g., ridge 112) and trap the grease so that it does not spill out during transport to a disposal location such as a trash can or recycling bin.

What is claimed is:

1. A drain pan liner for use in a drain pan of a grill, the grill having a grate and a grill grease outlet, the drain pan having drain pan grease outlet for flowing grease into the grill grease outlet, the drain pan liner comprising:
a bottom and sides formed of a rigid material and sized and shaped to fit into the drain pan;
an opening in an end of the drain pan liner sized and oriented to flow grease into the grill grease outlet;
wherein the drain pan liner is constructed and arranged such that it may be lifted out of the drain pan or inserted into the drain pan without requiring the grate or the drain pan to be removed from the grill.

2. The drain pan liner of claim 1 further constructed and arranged such that it may be lifted out of the drain pan or inserted into the drain pan without requiring the drain pan to be moved.

3. The drain pan liner of claim 1 further including a rigid end into which the opening is formed.

4. The drain pan liner of claim 3 wherein the opening is an aperture configured to feed a drip pan outlet channel, which passes through the grill grease outlet.

5. The drain pan liner of claim 1 wherein the opening comprises an open end of the drain pan.

6. The drain pan liner of claim 5 wherein the open end is configured to feed a grease trough formed into the grill, which feeds the grill grease outlet.

7. The drain pan liner of claim 1 further comprising ridges formed along the bottom of the drain pan liner.

8. The drain pan liner of claim 1 further comprising structure for facilitating resizing of the drain pan.

9. The drain pan liner of claim 8 wherein the resizing structure comprises markings to indicate cut lines.

9. The drain pan liner of claim 8 wherein the resizing structure comprises structure to facilitate tearing.

10. A plurality of drain pan liners according to claim 1 formed in a stack constructed and arranged for insertion into the drain pan such that a top drain pan liner may be lifted away without disarranging remaining drain pan liners in the stack and without disarranging the drain pan.

11. A plurality of drain pan liners according to claim 4 formed in a stack constructed and arranged for insertion into the drain pan such that a top drain pan liner may be lifted away without disarranging remaining drain pan liners in the stack and without disarranging the drain pan.

12. A plurality of drain pan liners according to claim 6 formed in a stack constructed and arranged for insertion into the drain pan such that a top drain pan liner may be lifted away without disarranging remaining drain pan liners in the stack and without disarranging the drain pan.

13. The method of cleaning grease and food particles from a grill having a grate and a drain pan comprising the steps of:
(a) disarranging the grate to access the drain pan;
(b) placing a drain pan liner within the drain pan without disarranging the drain pan;
(c) cooking with the grill;
(d) disarranging the grate to access the drain pan liner;
(e) removing the drain pan liner from the drain pan without disarranging the drain pan.

14. The method of claim 13, wherein steps (a) and (d) comprise the step of pivoting the grate upward without removing the grate from the grill.

15. The method of claim 13 wherein step (b) comprises placing a stack of drain pan liners within the drain pan, and wherein step (e) comprises removing a top drain pan liner from the stack without removing the rest of the stack.

16. The method of claim 13 wherein the drain pan liner includes an aperture and step (b) includes the step of placing the drain pan liner such that the aperture is adjacent to a drip pan outlet channel formed in the drip pan.

17. The method of claim 13 wherein the grill includes a grease trough and step (b) includes the step of placing the drain pan liner such that an opening in the drain pan liner is adjacent to the trough.

18. The method of claim 13 wherein step (d) is performed with a first hand and step (e) is performed with a second hand, and further including the step of:
(f) placing a drain pan liner within the drain pan without disarranging the drain pan.

19. The method of claim 18 wherein step (f) is performed with the second hand.

20. The method of claim 1 9 wherein steps (d), (e), and (f) are performed within one minute.
